(19) United States
(12) Patent Application Publication
(10) Pub. No.: US 2012/0317879 A1
(43) Pub. Date: Dec. 20, 2012

(54) Watering Systems, Platforms for Watering Systems, Greenhouses with Watering Systems, and Methods of Watering

(76) Inventors: Michael Morgan, Edina, MN (US); Michael Sean Gallant, Minneapolis, MN (US)

(21) Appl. No.: 13/580,134

(22) PCT Filed: Feb. 18, 2011
(86) PCT No.: PCT/US11/25474

§ 371 Date: Aug. 31, 2012

Related U.S. Application Data
(60) Provisional application No. 61/306,266, filed on Feb. 19, 2010.

(51) Int. Cl. A01G 9/24; A01G 9/00

(52) U.S. Cl. 47/17; 47/39

(57) ABSTRACT

Platforms, watering systems, greenhouses with watering systems, and methods of watering plants.

### CROSS-REFERENCE TO RELATED APPLICATIONS

This application claims priority to U.S. Provisional Patent Application Ser. No. 61/306,266, filed Feb. 19, 2010, which is incorporated herein in its entirety.

### BACKGROUND

1. Field of the Invention

The present invention relates generally to watering systems for plants. More particularly, but not by way of limitation, the present invention relates to flood-floor watering systems, greenhouses with watering systems, and methods of watering plants.

2. Background Information

Flood floors have been used in the past to water multiple plants, typically, for example, in industrial greenhouses. Typical flood floor watering systems use a sloped floor on which a plurality of plants sit. Known concrete flood floors may have concrete floors that typically slope about 1.5 vertical inches per about 10.5 horizontal feet. The concrete must be finished to a “perfect” plane. A low spot as thin as a dime will generally cause water to puddle, and may result in disease for the plants sitting in the puddle. Finishing of concrete floors to such exacting tolerances is typically very expensive, and few companies in North America are able or willing to finish concrete floors to such exacting standards.

Greenhouse “rooms” may have one or multiple basins or “slope channels” in a single room, and/or may be 50 to 1,000 feet long. The room length can have flood zones that are separated by curbs, stem walls, or flexible rubber baffles (about 4 inch tall) so individual basins or zones can be flooded separately. A fill pipe is typically positioned about 6 inches below the surface of the concrete, often with a series of holes (e.g., 1 inch diameter holes) at about 12 inch centers that may be core drilled through the concrete and into the fill pipe. Water can be introduced and removed through the fill pipe and holes.

The sloped floor is flooded with water such that plants sitting on a lower portion of the floor get more water (e.g., sit in deeper water during this flooding) than plants sitting on upper portions of the sloped floor, such that plants sitting on lower portions of the sloped floor may be exposed to too much water (e.g., volumes or depths of water that exceed optimal levels or impede optimal growth). Plants sitting on upper portions of the sloped floor are typically exposed to a shallower depth of water, and may not be exposed to enough water for optimal growth (e.g., volumes or depths of water that are insufficient to permit optimal growth).

### SUMMARY

The present disclosure includes embodiments of watering systems, greenhouses, and apparatuses for supporting plant containers.

In some embodiments of the present platforms for a watering system that comprises one or more surfaces defining a basin having an upper elevation and a lower elevation below the upper elevation, the basin configured to be fillable with liquid up to the upper elevation, the platform comprises: a platform configured to be disposed on at least one of the one or more surfaces such that the platform can support one or more plant containers at one or more support elevations between the upper and lower elevations of the basin.

Some embodiments of the present watering systems comprises: one or more surfaces defining a basin having an upper elevation and a lower elevation below the upper elevation, the basin configured to be fillable with liquid up to the upper elevation; and a platform disposed on at least one of the one or more surfaces and configured to support one or more plant containers at one or more support elevations between the upper and lower elevations of the basin.

Some embodiments further comprise: a drainage structure having a top elevation that is substantially even with or below the lower elevation of the basin, the drainage structure configured such that if liquid is in the basin drainage can be selectively permitted or prevented from the basin into the drainage structure.

In some embodiments, the platform is configured such that when the platform is disposed on the at least one of the one or more surfaces, at least five percent less liquid is required to fill the basin with liquid to the uppermost support elevation than is necessary to fill the basin to the same elevation when the platform is not in the basin. In some embodiments, the platform is configured such that when the platform is disposed on the at least one of the one or more surfaces, at least fifteen percent less liquid is required to fill the basin with liquid to the uppermost support elevation than is necessary to fill the basin to the same elevation when the platform is not in the basin. In some embodiments, the platform is configured such that when the platform is disposed on the at least one of the one or more surfaces, at least twenty five percent less liquid is required to fill the basin with liquid to the uppermost support elevation than is necessary to fill the basin to the same elevation when the platform is not in the basin. In some embodiments, the platform is configured such that when the platform is disposed on the at least one of the one or more surfaces, at least fifty percent less liquid is required to fill the basin with liquid to the uppermost support elevation than is necessary to fill the basin to the same elevation when the platform is not in the basin. In some embodiments, the platform is configured such that when the platform is disposed on the at least one of the one or more surfaces, at least seventy five percent less liquid is required to fill the basin with liquid to the uppermost support elevation than is necessary to fill the basin to the same elevation when the platform is not in the basin.

In some embodiments, the one or more surfaces include a surface with a curved cross-section defining at least a portion of a bottom of the basin. In some embodiments, the curved cross-section is concave such that the midpoint of the curved cross-section is at the lower elevation of the basin. In some embodiments, the curved cross-section is convex such that the midpoint of the curved cross-section is above the lower elevation of the basin and such that the one or more surfaces define two basins each having a lower elevation.

In some embodiments, the drainage structure comprises two drainage structures each corresponding to a different one of the two basins. In some embodiments, the one or more surfaces include a substantially level bottom surface and a plurality of side surfaces. In some embodiments, the plurality of side surfaces are substantially vertical. In some embodiments, the one or more surfaces include a plurality of stepped bottom surfaces and a plurality of side surfaces. In some embodiments, the plurality of stepped bottom surfaces include a plurality of surfaced stepped from an upper step elevation to a plurality of sequentially lower step elevations. In some embodiments, the one or more surfaces include a bottom surface sloping downward to the lower elevation. In some embodiments, the one or more surfaces include two sloped bottom surfaces defining a bottom of the basin having a V-shaped cross-section. In some embodiments, the vertex of the V-shaped cross-section is at the lower elevation of the basin.

Some embodiments further comprise: a walkway. In some embodiments, the walkway is integral to the platform. In some embodiments, the walkway is disposed above and substantially parallel to at least a portion of the drainage structure. In some embodiments, the walkway and at least a portion of the drainage structure are elongated and disposed perpendicular to the slope of the sloped bottom surfaces. In some embodiments, the vertex of the V-shaped cross-section is above the lower elevation of the basin such that the one or more surfaces define two basins each having a lower elevation. In some embodiments, the one or more surfaces include four sloped bottom surfaces defining a W-shaped cross-section such that the one or more surfaces define two basins each having a V-shaped cross-section with a lower elevation at the vertex of the V-shaped cross-section. In some embodiments, the drainage structure comprises two drainage structures each corresponding to a different one of the two basins. Some embodiments comprise two walkways, each disposed above and substantially parallel to a different one of the two drainage structures.

In some embodiments, the platform comprises a platform disposed in each basin. In some embodiments, each platform is porous. In some embodiments, the platform is configured to support a plurality of plant containers at a plurality of support elevations. In some embodiments, the platform is configured to support a plurality of plant containers at a single support elevation. In some embodiments, the platform comprises a plurality of layers. In some embodiments, the plurality of layers are coupled together. In some embodiments, each of the plurality of layers comprises a grating, a mat, or a geonetting. In some embodiments, the plurality of layers have a plurality of different sizes. In some embodiments, the plurality of different sizes sequentially increase in size from the bottom of the platform to the top of the platform.

In some embodiments, the platform comprises one or more of: rubber, plastic, polymer, polypropylene, polyethylene, polyvinyl chloride (PVC), ethylene propylene diene Monomer (EPDM) rubber, high-density polyethylene (HDPE), linear low-density polyethylene (LLDPE), and resin. In some embodiments, the platform comprises a plurality of bricks, tiles, or stones, or comprises concrete. In some embodiments, the watering system comprises at least one liner disposed under the platform. In some embodiments, the liner comprises one or more of: rubber, plastic, polymer, polypropylene, polyethylene, polyvinyl chloride (PVC), ethylene propylene diene Monomer (EPDM) rubber, high-density polyethylene (HDPE), linear low-density polyethylene (LLDPE), and resin. In some embodiments, the liner is coupled to the platform. In some embodiments, the liner is integral to the platform. In some embodiments, the liner is at least partially supported by a subgrade, and the subgrade comprises the one or more surfaces defining the basin. In some embodiments, the subgrade comprises one or more of compacted clay, concrete, ash, sand, and dirt.

In some embodiments, at least part of the drainage structure is above the liner. In some embodiments, at least part of the drainage structure is below the liner. In some embodiments, the drainage structure comprises one or more open channels each in fluid communication with a basin and having a flowline below the lower elevation of the basin. In some embodiments, the drainage structure comprises one or more pipes each in fluid communication with a basin and having a flowline below the lower elevation of the basin. In some embodiments, the basin or basins have a nominal overall width of twenty feet. In some embodiments, the basin or basins have a nominal overall length of 500 feet. In some embodiments, at least a portion of the one or more surfaces is defined by baffle walls that divide a basin into a plurality of subbasins.

Some embodiments of the present greenhouses comprise: any of the present watering systems; a plurality of walls; and a roof.

Some embodiments of the present methods comprise: introducing liquid into at least one basin of any of the present watering systems having a plurality of plant containers disposed on the platform. In some embodiments, at least some of the plurality of plant containers are disposed at a slope that is less than the slope of at least one of the one or more surfaces beneath the plant containers. In some embodiments, the plant containers are disposed at a substantially constant support elevation on the platform. In some embodiments, introducing liquid comprises introducing liquid into the at least one basin through the drainage structure. Some embodiments further comprise: permitting the liquid to drain from the at least one basin through the drainage structure. In some embodiments, the liquid comprises water. In some embodiments, the liquid comprises fertilizer.

Some embodiments of the present methods comprise: permitting liquid to drain from at least one basin of any of the present watering systems having a plurality of plant containers disposed on the platform. In some embodiments, at least some of the plurality of plant containers are disposed at a slope that is less than the slope of at least one of the one or more surfaces beneath the plant containers. In some embodiments, the plant containers are disposed at a substantially constant support elevation on the platform. In some embodiments, permitting liquid to drain comprises permitting liquid to drain from the at least one basin through the drainage structure. In some embodiments, the liquid comprises water. In some embodiments, the liquid comprises fertilizer.

Some embodiments of the present apparatuses are configured to support plant containers in a greenhouse, and comprise: a platform shaped to be placed in a basin defined by at least a portion of a floor of the greenhouse, where the platform: has a first side edge and an opposing second side edge that is thicker than the first side edge; and includes at least a portion that is porous. In some embodiments, the platform comprises a first platform and the apparatus further comprises: a second platform shaped to be placed in the basin, where the second platform: has a first side edge and an opposing second side edge that is thicker than the first side edge; and includes at least a portion that is porous; and a third platform configured to be coupled to and between the first and second platforms, the third platform being thinner than the second side edges of the first and second platforms. In some embodiments, the platform is configured to comprise in use a first intermediate longitudinal section and a second longitudinal section, and the first intermediate longitudinal section is thicker than the first side edge and the second side edge is thicker than the second intermediate longitudinal section. In some embodiments, the platform comprises multiple sections couplable together. Some embodiments further comprise: a liner over which the platform or platforms are configured to be positioned. In some embodiments, the liner is coupled to the platform. In some embodiments, the liner is integral to the platform. In some embodiments, the liner comprises one or more of: rubber, plastic, polymer, polypropylene, polyethylene, polyvinyl chloride (PVC), ethylene propylene diene Monomer (EPDM) rubber, high-density polyethylene (HDPE), linear low-density polyethylene (LLDPE), and resin. In some embodiments, each platform comprises multiple layers couplable together in stacked fashion. In some embodiments, each platform is made from a single layer of molded material.

Some embodiments of the present apparatuses are configured to support plant containers in a greenhouse, and comprise: a platform shaped to be placed in a basin defined by at least a portion of a floor of the greenhouse, where the platform is configured to comprise in use a first side edge, an opposing second side edge, and a middle portion, the middle portion being thicker than the first side edge and than the second side edge; where the platform includes at least a portion that is porous. In some embodiments, the platform comprises multiple sections couplable together. Some embodiments further comprise: a liner over which the platform or platforms are configured to be positioned. In some embodiments, the liner is coupled to the platform. In some embodiments, the liner is integral to the platform. In some embodiments, the liner comprises one or more of: rubber, plastic, polymer, polypropylene, polyethylene, polyvinyl chloride (PVC), ethylene propylene diene Monomer (EPDM) rubber, high-density polyethylene (HDPE), linear low-density polyethylene (LLDPE), and resin. In some embodiments, each platform comprises multiple layers couplable together in stacked fashion. In some embodiments, each platform is made from a single layer of molded material.

Some embodiments of the present apparatuses are configured to support plant containers in a greenhouse, and comprise: a platform shaped to be placed in a basin defined by at least a portion of a floor of the greenhouse, where the platform is configured to comprise in use a first side edge and an opposing second side edge substantially equal in thickness to the first side edge, and a middle portion, the middle portion being substantially equal in thickness to the first side edge and to the second side edge; where the platform includes at least a portion that is porous. In some embodiments, the platform comprises multiple sections couplable together. Some embodiments further comprise: a liner over which the platform or platforms are configured to be positioned. In some embodiments, the liner is coupled to the platform. In some embodiments, the liner is integral to the platform. In some embodiments, the liner comprises one or more of: rubber, plastic, polymer, polypropylene, polyethylene, polyvinyl chloride (PVC), ethylene propylene diene Monomer (EPDM) rubber, high-density polyethylene (HDPE), linear low-density polyethylene (LLDPE), and resin. In some embodiments, each platform comprises multiple layers couplable together in stacked fashion. In some embodiments, each platform is made from a single layer of molded material.

Some embodiments of the present apparatuses are configured to support plant containers in a greenhouse, and comprise: a platform shaped to be placed in a basin defined by at least a portion of a floor of the greenhouse, where the platform is configured to comprise in use a first side edge, an opposing second side edge, and a middle portion, the middle portion being thinner than the first side edge and than the second side edge; where the platform includes at least a portion that is porous. In some embodiments, the platform comprises multiple sections couplable together. Some embodiments further comprises: a liner over which the platform or platforms are configured to be positioned. In some embodiments, the liner is coupled to the platform. In some embodiments, the liner is integral to the platform. In some embodiments, the liner comprises one or more of: rubber, plastic, polymer, polypropylene, polyethylene, polyvinyl chloride (PVC), ethylene propylene diene Monomer (EPDM) rubber, high-density polyethylene (HDPE), linear low-density polyethylene (LLDPE), and resin. In some embodiments, each platform comprises multiple layers couplable together in stacked fashion. In some embodiments, each platform is made from a single layer of molded material.

Some embodiments of the present apparatuses are configured to support plant containers in a greenhouse, and comprise: a platform shaped to be placed in a basin defined by at least a portion of a floor of the greenhouse, where the platform includes at least a portion that is porous; and a liner over which the platform is configured to be positioned. In some embodiments, the platform comprises multiple sections couplable together. In some embodiments, the liner is coupled to the platform. In some embodiments, the liner is integral to the platform. In some embodiments, the liner comprises one or more of: rubber, plastic, polymer, polypropylene, polyethylene, polyvinyl chloride (PVC), ethylene propylene diene Monomer (EPDM) rubber, high-density polyethylene (HDPE), linear low-density polyethylene (LLDPE), and resin. In some embodiments, each platform comprises multiple layers couplable together in stacked fashion. In some embodiments, each platform is made from a single layer of molded material.

Some embodiments of the present apparatuses are configured to support plant containers in a greenhouse, and comprise: one or more trays shaped to be placed in a basin defined by at least a portion of a floor of the greenhouse, where the one or more trays includes at least a portion that is porous, and one of the one or more trays varies in thickness along its length; and a liner over which the one or more trays is configured to be positioned. In some embodiments, the one or more trays comprises multiple trays. In some embodiments, the liner comprises one or more of: rubber, plastic, polymer, polypropylene, polyethylene, polyvinyl chloride (PVC), ethylene propylene diene Monomer (EPDM) rubber, high-density polyethylene (HDPE), linear low-density polyethylene (LLDPE), and resin.

Some embodiments of the present apparatuses are configured to support plant containers in a greenhouse, and comprise: a tray that includes a portion that is porous, that has a height and a length, and the height varies at different locations along the length.

Some embodiments of the present apparatuses are configured to support plant containers in a greenhouse, and comprise: a tray that includes a portion that is porous and that has a top surface that lies substantially in a plane and a bottom surface that is disposed at a non-zero angle to the top surface, thereby allowing the top surface of the tray to be positioned in a substantially level manner when the bottom surface is placed against a slanted surface that substantially matches the non-zero angle.

Embodiments of the present trays may have a length that is greater than 2, 3, 4, 5, 6, 7, 8, 9, 10, 11, 12, 13, 14, 15, 16, 17, 18, 19, 20, 30, 40, or 50 feet and/or embodiments of the present trays may have a length that is no greater than 2, 3, 4, 5, 6, 7, 8, 9, 10, 11, 12, 13, 14, 15, 16, 17, 18, 19, 20, 30, 40, or 50 feet.

Some embodiments of the present methods of supporting plant containers in a greenhouse comprise: disposing one or more trays over a basin defined by at least a portion of a floor of the greenhouse, where the one or more trays includes at least a portion that is porous, and one of the one or more trays varies in thickness along its length. Some embodiments of the present methods further comprise: placing a liner over the basin, and where the disposing comprises placing the one or more trays on the liner. In some embodiments, the one or more trays comprises multiple trays. In some embodiments, the liner comprises one or more of: rubber, plastic, polymer, polypropylene, polyethylene, polyvinyl chloride (PVC), ethylene propylene diene Monomer (EPDM) rubber, high-density polyethylene (HDPE), linear low-density polyethylene (LLDPE), and resin.

In some embodiments, any of the present platforms and trays can be characterized by at least one dimension of at least five feet and at least one other dimension of at least ten feet. Furtheiniore, any of the present platforms may comprise multiple segments that can be coupled together (and, in some embodiments, that are coupled together).

Any embodiment of any of the present systems and/or methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

Details associated with the embodiments described above and others are presented below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1 depicts an cross-sectional view of a greenhouse with a flood floor watering system.

FIG. 2 depicts a cross-sectional end view of one of the present watering systems.

FIG. 3 depicts another cross-sectional end view of the watering system of FIG. 2.

FIGS. 4A-4C depict perspective views certain elements of some embodiments of the present watering systems.

FIGS. 5A-5D depict alternate drainage structures suitable for use in some embodiments of the present watering systems.

FIGS. 6-15 depict cross-sectional end views of various embodiments of the present watering systems.

FIGS. 16-17 depict a cross-sectional end view and a top plan view, respectively, of another embodiment of the present watering systems.

FIGS. 18-21 depict cross-sectional end views of various embodiments of the present watering systems.

### DESCRIPTION OF ILLUSTRATIVE EMBODIMENTS

The term “coupled” is defined as connected, although not necessarily directly, and not necessarily mechanically; two items that are “coupled” may be integral with each other. The terms “a” and “an” are defined as one or more unless this disclosure explicitly requires otherwise. The terms “substantially,” “approximately,” and “about” are defined as largely but not necessarily wholly what is specified, as understood by a person of ordinary skill in the art.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method that “comprises,” “has,” “includes” or “contains” one or more steps possesses those one or more steps, but is not limited to possessing only those one or more steps. Likewise, a watering system that “comprises,” “has,” “includes” or “contains” one or more elements possesses those one or more elements, but is not limited to possessing only those elements. For example, in a watering system that comprises one or more surfaces and a platform, the watering system includes the specified elements but is not limited to having only those elements. For example, such a watering system could also include a drainage structure.

Further, a device or structure that is configured in a certain way is configured in at least that way, but it can also be configured in other ways than those specifically described.

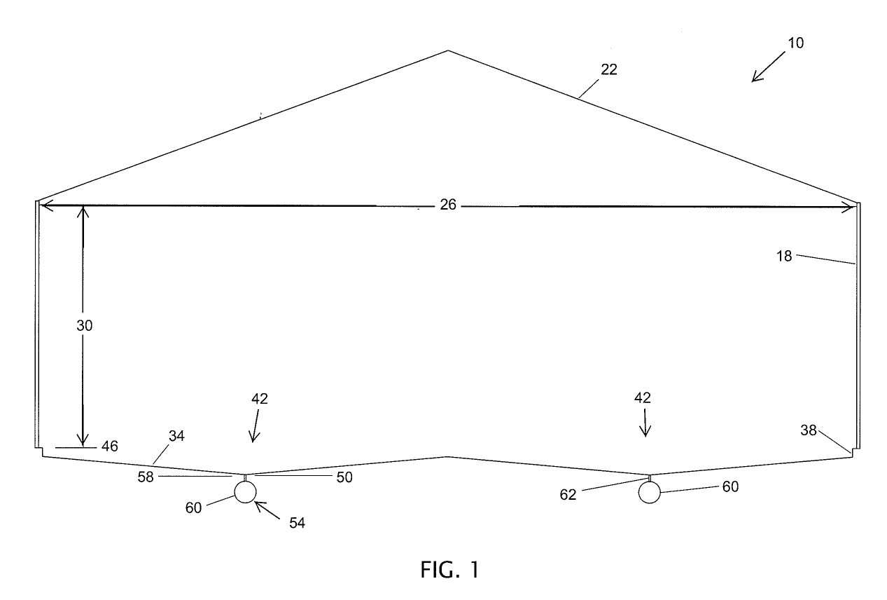

Referring now to the drawings, and more particularly to FIG. 1, shown therein and designated by the reference numeral 10 is one embodiment of the present greenhouses that can include and/or be fitted with one of the present watering systems. Not all elements are numbered in all of the present figures. Unless clear from the context of the description of a particular embodiment, any of the elements described in this disclosure can be present in any of the embodiments shown in any of the present structures, whether numbered or not in a figure, and whether specifically mentioned or not in relation to the figure.

Greenhouse 10 generally comprises a floor 14, a plurality of walls 18, and a roof 22. In some embodiments, walls 18 and/or roof 22 comprise a transparent or translucent material such as, for example, glass or plastic. Greenhouse 10 has a width 26 (extending between opposing, and usually substantially parallel, walls 18) and a height 30 (extending between the uppermost portion of floor 14 adjacent wall 18 and the top of the wall). Width 26 can be any suitable size, such as, for example, equal to, greater than, less than, or between any of: 12, 13, 14, 15, 16, 17, 18, 19, 20, 21, 22, 23, 24, 25, 26, 27, 28, 29, 30, 31, 32, 33, 34, 35, 36, 37, 38, 39, 40, or more feet. For example, commercial greenhouses typically have a width between 16 and 32 feet. Height 30 can also be any suitable size, such as, for example, equal to, greater than, less than, or between any of: 6, 7, 8, 9, 10, 11, 12, 13, 14, 15, 16, 17, 18, 19, 20, or more feet. For example, commercial greenhouses typically have a height of about 12 feet. Greenhouse 10 can comprise any suitable construction, such as, for example, a metal frame with glass panels, or plastic panels or sheets (rigid or flexible) that permit light to enter the greenhouse. In some embodiments, posts or vertical supports to support the roof, panels, and/or sheeting may be disposed on about 12-foot centers along the top of curbs 32. Concrete footings about 6 to 8 inch diameter may be desired and/or structurally required to set and/or support such posts or vertical supports.

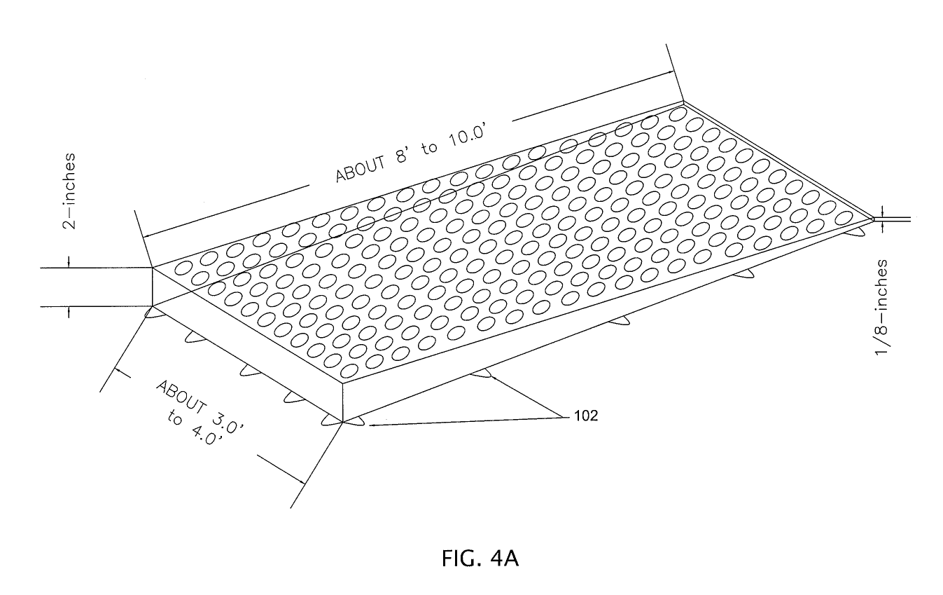

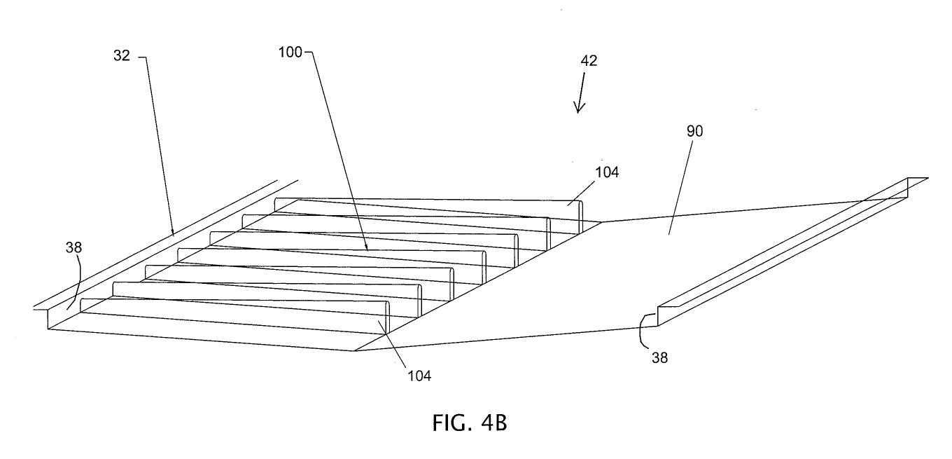

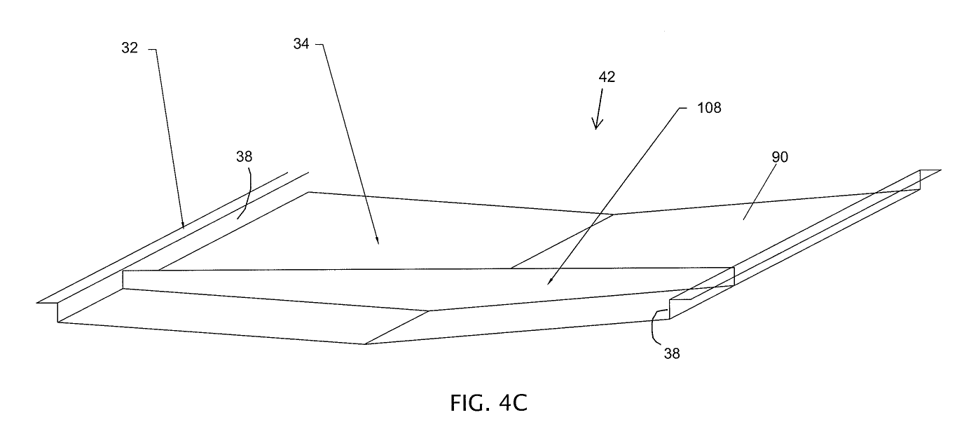

In the embodiment shown, greenhouse 10 (e.g., floor 14) comprises one or more surfaces (e.g., bottom surfaces 34, side surfaces 38, end surfaces (not shown)) defining a basin 42 (e.g., two basins 42, in the embodiment shown) having an upper elevation 46 and a lower elevation 42 below the upper elevation, and configured to be fillable with water (i.e., configured such that the basin or basins can be filled with water) up to the upper elevation. For example, end surfaces of a basin can be defined by baffles or baffle walls (FIG. 4C) that can either define the end of a basin 42 or can divide what would otherwise be a longer basin into two shorter basins (e.g., divides a basin into a plurality of subbasins). In some embodiments, such baffles may be flexible (e.g., may comprise rubber), and/or may have a height of about four (4) inches tall when in use. In some embodiments, each of one or more basins has a nominal overall length of, for example, equal to, greater than, less than, or between any of 50, 100, 200, 250, 300, 400, 500, 600, 700, 750, 800, 900, 1000, or more feet.

For example, basins can be divided with baffle walls (e.g., baffle wall 108 of FIG. 4C) or dams having a height of between (and/or tapered between) ½ inch and 10 inches, and spanning the width of the greenhouse floor and/or an individual basin. Outside edges or “curbs” 32 of a greenhouse or flood zone can comprise (and/or be formed of) concrete, the same material as the subgrade, and/or other suitable material. Plant containers will generally contain soil and a plant and/or one or more seeds. Most plant containers will be supported by the platform, however, some (e.g., at the periphery of a basin adjacent the upper level of the basin) may be supported by the one or more bottom or floor surfaces.

In some embodiments, each basin 42 can be configured to have a different upper elevation and/or a different lower elevation. In the embodiment shown, each basin 42 has two bottom surfaces 34 that slope to the lower elevation substantially at the center of the basin. In other embodiments, the lower elevation need not be at the center of the basin (e.g., can be at a side adjacent a side surface 38, can be off-center and spaced apart from each of two side surfaces, etc.). The bottom surface(s) can be sloped at any suitable slope or grade, such as, for example, equal to, greater than, less than, or between any of: ⅛ inch-per-foot, 3/16 inch-per-foot, ¼ inch-per-foot, 5/16 inch-per-foot, ⅜ inch-per-foot, 7/16 inch-per-foot, ½ inch-per-foot, 1%, 2%, 3%, 4%, 5%, 6%, 7%, 8%, 9%, 10%, or more. The basin or basins 42 are sized to fit within the walls of the greenhouse (e.g., have a nominal overall width corresponding to width 26 of the greenhouse). For example, if the greenhouse has a width of 20 feet, floor 14 (e.g., basins 42) have a nominal overall width of 20 feet, even though the basins may have a width that is less than 20 feet.

Floor 14 can comprise, and/or be formed of, and/or be defined by, any suitable structure or combination of structures. For example, in some embodiments, floor 14 comprises a layer of concrete or cement over dirt (e.g., earth) and/or subgrade.

In the embodiment shown, greenhouse 10 (e.g., floor 14) also comprises a drainage structure 54 (e.g., two drainage structure 54, in the embodiment shown, one for each basin 42) having a top elevation 58 that is substantially even with (or, in other embodiments, below lower elevation 50 of the respective basin 42). In some embodiments, drainage structures 54 each have a different top elevation 58 at or below the lower elevations of their respective basins 42. In the embodiment shown, each drainage structure 54 comprises a pipe 60 below a low-point (e.g., corresponding to the lower elevation 50) of the respective basin 42, and a plurality of holes 62 formed (e.g., drilled) through the floor and into pipe 60. Holes 62 can have any suitable shape and transverse dimension (e.g., circular shape and diameter). For example, in the embodiment shown, holes 62 have a circular shape and a diameter of one or two inches.

Each drainage structure 54 is configured such that if liquid is in the basin, drainage can be selectively permitted or prevented from the basin into the drainage structure. For example, in the embodiment shown, pipe 60 has a flowline that is below (e.g., such that the top of pipe 60 is about 6 inches below) lower elevation 50 of the basin at any given point, such that: (1) if pipe 60 is filled with water and additional water is added to pipe 60, then the additional water will flow through holes 62 and add water to the respective basin 42; and (2) if the water is permitted to drain out of pipe 60, any additional water in the respective basin will be permitted to drain from the basin 42, through holes 62, and into pipe 60. In some embodiments, pipe 60 is sloped along its longitudinal axis to discourage pooling or ponding of liquid (e.g., water) in pipe 60 when liquid is permitted to drain out of the pipe. In some embodiments, the upper surface (which may also be characterized as the support surface or plant container support surface) of the platform is level or substantially level; in some embodiments where the upper surface of the platform is sloped, the slope of the upper surface is less than the slope of the bottom surface of the basin beneath it.

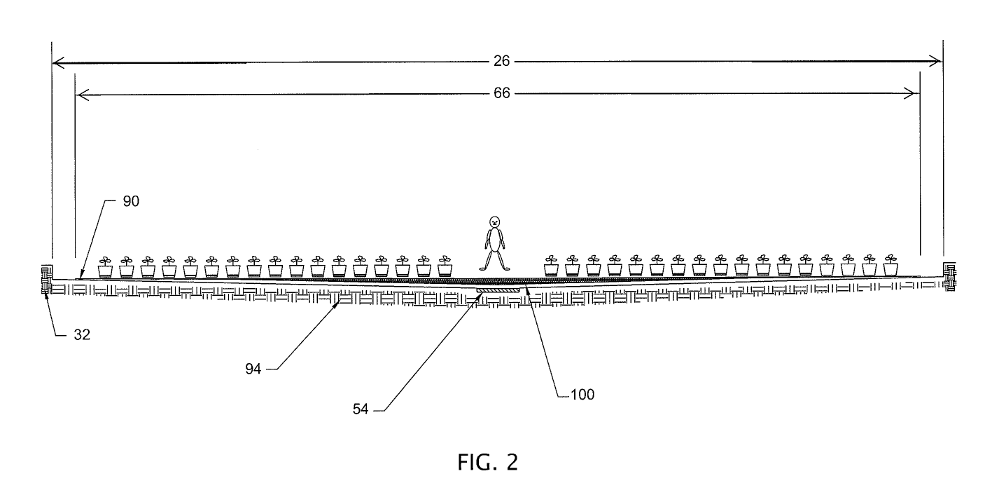

Referring now to FIG. 2, shown therein and designated by the reference numeral 100 is one of the present watering systems having a V-shaped floor and/or liner. In the embodiment shown, the watering system comprises: one or more surfaces defining a basin having an upper elevation and a lower elevation below the upper elevation, the basin configured to be finable with liquid up to the upper elevation; a platform 100 disposed on at least one of the one or more surfaces (e.g., one or more bottom surfaces) and configured to support one or more plant containers at one or more support elevations between the upper and lower elevations of the basin; a drainage structure 54 having a top elevation that is substantially even with or below the lower elevation of the basin, the drainage structure configured such that if liquid is in the basin drainage can be selectively permitted or prevented from the basin into the drainage structure. In the embodiment shown, the platform is configured to support a plurality of plant containers at a single support elevation (e.g., such that the basin can be filled to an elevation above the support elevation but below the upper elevation of the basin to water plants in the plurality of plant containers). In other embodiments, the platform can be configured to support a plurality of plant containers at a plurality of support elevations (e.g., the top of the platform can be staggered, stepped, curved, angled, etc.). In the embodiment shown, platform 100 has a width 66 that is less than width 26. For example, width 66 and/or other dimensions of platform 100 may be configured such that the upper elevation of the platform is at or near the uppermost elevation of bottom surface 34.

In the embodiment shown, the one or more surfaces include a bottom surface sloping from the upper elevation to the lower elevation. More particularly, in the embodiment shown, the one or more surfaces include two sloped bottom surfaces defining a bottom of the basin having a V-shaped cross-section, where the vertex of the V-shaped cross-section is at the lower elevation of the basin. In the embodiment shown, the one or more surfaces also a plurality of side surfaces (e.g., two substantially opposing vertical side surfaces). As used in this disclosure, “opposing” means opposite, but not necessarily parallel (e.g., two opposing sides are spaced apart and spatially opposite each other to some degree, but are not necessarily parallel).

In some embodiments, floor 14 comprises a liner 90 (e.g., a flexible and/or rigid and/or water-impermeable liner), such as, for example, a liner comprising one or more of: rubber, plastic, polymer, polypropylene, polyethylene, polyvinyl chloride (PVC), ethylene propylene diene Monomer (EPDM) rubber, high-density polyethylene (HDPE), linear low-density polyethylene (LLDPE), resin, and/or any other substantially impermeable sheet material. For example, in some embodiments, the liner comprises EPDM geomembrane (rubber sheeting, about 4/100 to 6/100 of an inch thick). The liner can be water-tight (impermeable to water), from curb/side to curb/side, and end to end, of each room, and/or: can terminate at the perimeter of a room or flood zone, extend into adjacent rooms, and/or be secured to a concrete curb border with a batten bar and/or other attachment structure(s) or device(s). For example, batten bars are typically stamped from flat stock metal (e.g., about ⅛″×1″×10-ft) with holes at about 6 inch centers, and can be attached to the wall or a stem wall with standard hammer-in anchors (e.g., for concrete). In some embodiments, the liner is at least partially supported by a subgrade 94, (e.g., a subgrade comprising one or more of compacted clay, concrete, ash, sand, and dirt). In the embodiment shown, the subgrade comprises the one or more surfaces defining the basin. In some embodiments, the liner is coupled to (and/or integral to) the platform (e.g., a bottom of the platform).

In the embodiment shown, the platform is configured such that when the platform is disposed on at least one of the one or more surfaces, at least five percent less liquid is required to fill the basin with liquid to the uppermost support elevation than is necessary to fill the basin to the same elevation when the platform is not in the basin. In some embodiment, the platform is configured such that when the platform is disposed on at least one of the one or more surfaces, at least fifteen percent less liquid (e.g., and/or at least twenty five percent, at least fifty percent, at least seventy five percent, etc., less liquid) is required to fill the basin with liquid to the uppermost support elevation than is necessary to fill the basin to the same elevation (in the basin) when the platform is not in the basin. For example, in the embodiment shown, the platform is porous (e.g., has openings extending through the platform) such that liquid can pass through at least some portion of the platform while the solid portions of the platform occupy a portion of the volume in the basin (e.g., such that less water is required to fill the basin to a selected elevation while the platform is disposed in the basin).

Some embodiments of the present apparatuses configured to support plant containers in a greenhouse, comprise: a platform 100 shaped to be placed in a basin defined by at least a portion of a floor of the greenhouse, where the platform is configured to comprise in use a first side edge, an opposing second side edge, and a middle portion, the middle portion being thicker than the first side edge and than the second side edge; where the platform includes at least a portion that is porous. The platform, as with any of the present platforms in some embodiments, can be characterized by at least one dimension of at least five feet (e.g., 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50 feet or more, including every integer between 50 feet and 10,000 feet) and at least one other dimension of at least ten feet (e.g., 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50 feet or more, including every integer between 50 feet and 10,000 feet). In some embodiments, the platform comprises multiple sections couplable together (e.g., such that multiple sections are coupled end-to-end, side-to-side, or both), such as with, for example, clips, ties, screws, wire, twine, adhesive, welds, bolts, tape, or any other suitable structure or coupling device. Each platform (or each segment of some or every platform) may be made from a single layer of molded material. Some embodiments of the present apparatuses further comprise a liner over which the platform is configured to be positioned. In some embodiments, the liner comprises one or more of rubber, plastic, polymer, polypropylene, polyethylene, polyvinyl chloride (PVC), ethylene propylene diene Monomer (EPDM) rubber, high-density polyethylene (HDPE), linear low-density polyethylene (LLDPE), resin, and/or any other substantially impermeable sheet material. The liner in such embodiments can be a separate structure from the platform or, in some embodiments, integral with the platform.

The platform can be configured to permit liquid (e.g., water) to move through the platform (e.g., via openings through the platform), such as, for example, in three dimensions (e.g., vertically, longitudinally, laterally). The platform can also be configured to support a person (e.g., the weight of a person walking on the platform or a portion of the platform) and/or to support a vehicle such as a four-wheeler or all-terrain vehicle (ATV) (e.g., the weight of a vehicle driving on the platform or a portion of the platform), such that the platform is not rendered unusable after such a vehicle has driven over it. In some embodiments, the platform (or platform segments) may comprise a grating, a mat, or geonetting (geonet material).

In some embodiments, each platform comprises multiple layers couplable together in stacked fashion. For example, in the embodiment shown, the platform comprises a plurality of layers. In the embodiment shown, the plurality of layers have a plurality of different sizes (e.g., sequentially increasing in size from the bottom of the platform to the top of the platform). For example, in the embodiment shown, in which the nominal overall width of the basin is 20 feet, the platform comprises six layers of geonetting (e.g., Agru America, Inc.'s Geonet (Georgetown, S.C.)) or mat in which the first (top) layer has a width of 15 feet, the second layer has a width of 12.5 feet, the third layer has a width of 10 feet, the fourth layer has a width of 7.5 feet, the fifth layer has a width of 5 feet, and the sixth (bottom) layer has a width of 2.5 feet, such that the platform can be disposed on the angled bottom surfaces (floor) and the top layer can support a plurality of plant containers at one or more support elevations (e.g., a single or substantially single support elevation). In some embodiments, the plurality of layers are coupled together (e.g., with clips, ties, screws, wire, twine, adhesive, welds, bolts, tape, or any other suitable structure or coupling device). In some embodiments, each of the plurality of layers comprises a grating, a mat, or a geonetting. In the embodiment shown, individual layers can have a thickness of between ⅛ inch and 2 inches (e.g., 1.5 inches).

In the embodiment shown, the drainage structure comprises a channel in the floor (e.g., above a liner and below the platform), such as, for example, in which a corrugated and/or perforated pipe having a flattened cross-sectional shape is disposed, as shown. In some embodiments, the drainage structure comprises one or more open channels each in fluid communication with a basin and having a flowline below the lower elevation of the basin.

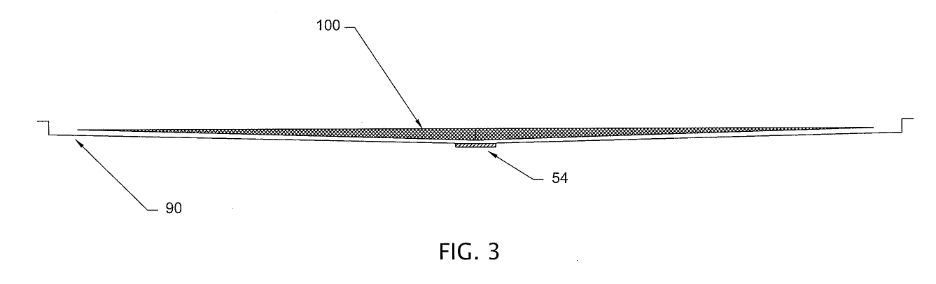

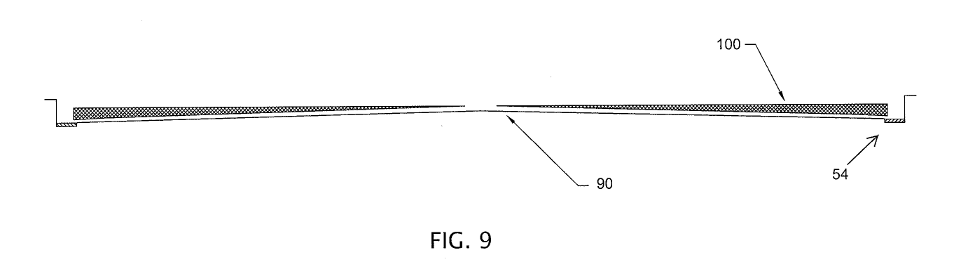

Referring now to FIGS. 3 and 4A, FIG. 3 depicts another embodiment of the present watering systems that is substantially similar to the embodiment shown in FIG. 2, with the primary difference that the platform has a single molded layer (rather than comprising multiple layers), and FIG. 4A depicts a platform suitable for use in the watering system of FIG. 3 when coupled to another platform. In the embodiment shown, the platform has a relatively thin side and a relatively thick side such that two platforms segments can be coupled to one another such that their relatively thick sides abut and form the overall platform shape shown in FIG. 3. The platform segment of FIG. 4A can be formed by any suitable methods and can comprise any suitably durable material (e.g., rubber, plastic, or the like). The dimensions shown in FIG. 4 are exemplary only, and do not limit the size or shape of the platform segment or of any other embodiments of the present platforms. Stated another way, FIG. 4A depicts an apparatus configured to support plant containers in a greenhouse, the apparatus comprising: a platform shaped to be placed in a basin defined by at least a portion of a floor of the greenhouse, where the platform: has a first side edge and an opposing second side edge that is thicker than the first side edge; and includes at least a portion that is porous. In some embodiments, the platform may be characterized by at least one dimension of at least five feet, and at least one other dimension of at least ten feet. As is described for various embodiments below, drainage structures 54 may be included medially (e.g., at the center of a basin as in FIG. 3), and/or laterally (e.g., at the side of a basin as in FIG. 9). In the embodiment shown, the platform segment includes tabs 102 (or other structure 102, e.g., holes for bolts, rivets, or ties) for coupling segments together.

FIG. 4B depicts a perspective view of one of the present watering systems in which the subgrade supports a liner 90 and defines a basin 42 with side surfaces 38. FIG. 4B depicts a portion of a platform (a plurality of vertical sections 104 of a platform) to conceptually illustrate the volume of the basin that can be occupied by certain configurations of the present watering systems. The platform and liner of this embodiments may be of unitary construction, and/or may be poured, cast, or molded together (e.g., of rubber, plastic or concrete). In the embodiment shown, only one side of the platform is shown for clarity; however, the platform may include a second (right) side that is substantially similar to the (left) side shown. FIG. 4C depicts a perspective view of a portion of one of the present watering systems in which the platform is omitted for clarity, but in which the subgrade supports a liner 90 and defines a basin 42 with side surfaces 38. FIG. 4C also depicts one of the present baffle walls 108 and spanning the width of basin 42 to divide the length of the basin into a plurality of subbasins.

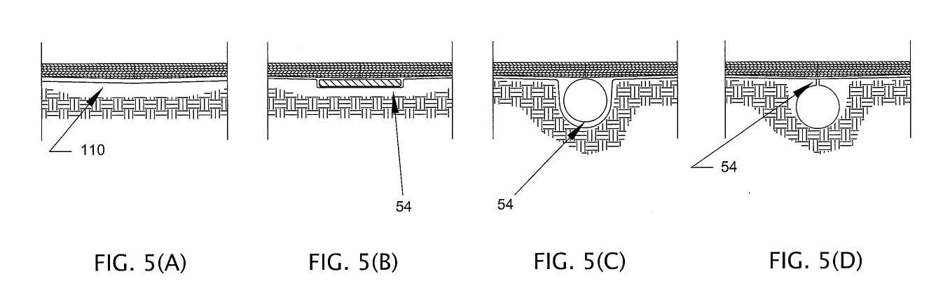

Referring now to FIGS. 5(A)-5(D), different embodiments of the present watering systems are shown. In the examples shown, the thickness of the platform at the center of the basin is about 1.5 inches. In some embodiments, no drainage structure is used; in other embodiments, the drainage structure (or at least part of the drainage structure) is above the liner; in other embodiments, the drainage structure (or at least part of the drainage structure) is below the liner. For example, FIG. 5(A) depicts an embodiment that includes a platform (in which at least a portion of the platform is porous), and a liner beneath the platform (does not include a pipe) configured such that water can move (e.g., drain) along a valley 110 in the center of the basin. FIG. 5(B) depicts an embodiment similar that of FIG. 5(A) but including a drainage structure 54 that comprises a flat, perforated pipe (e.g., flattened and/or corrugated) positionable (e.g., positioned) above the liner and in a channel such that liquid may be permitted to flow from the basin into the pipe through the perforations. FIG. 5(C) depicts a drainage structure 54 that is similar to that of FIG. 5(B) but having a different cross-sectional shape (circular) and having a perforated (and/or corrugated) pipe in the channel such that liquid may be permitted to flow from the basin into the pipe through the perforations. FIG. 5(D) depicts an embodiment in which the drainage structure 54 is similar to that of FIG. 1, and the drainage structure is positioned beneath/below a liner through which holes have been formed (e.g., in concrete or other subgrade between the pipe and the liner to permit fluid communication between the pipe and the basin). Each of the drainage structures of FIGS. 5(B)-5(D) comprises one or more pipes each in fluid communication with a basin and having a flowline below the lower elevation of the basin.

Any of these embodiments of drainage structures may be suitable for use with various embodiments of the present watering systems, and/or may be modified and/or substituted with any other drainage structures that permit the watering system to function as described. Additionally, some embodiments can comprise any suitable watering structure for introducing water into and/or filling each basin (e.g., the drainage structure(s) may be used to fill the basin). For example, water may be introduced into a basin through the platform (e.g., a hose or other tube coupled to a platform such that the pores of the platform help diffuse the water to prevent erosion and the like), through a spillway or the like at an edge of the basin, and/or a depression or channel in the liner (e.g., with or without a perforated and/or corrugated pipe) that allows water to flow under the platform, a pipe disposed below the liner with holes between the basin and the pipe to permit water to flow into the basin, and/or any combination of these options.

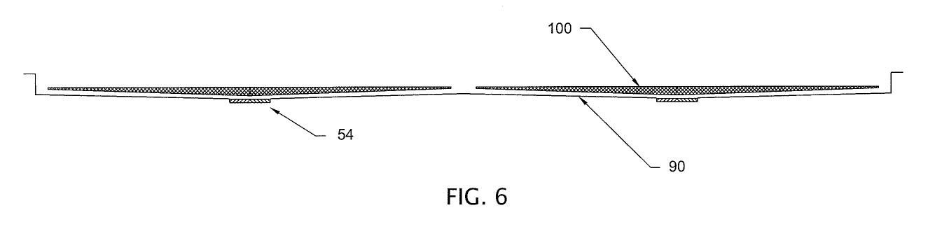

Referring now to FIG. 6, another embodiment of the present watering systems is shown that is substantially similar to the embodiment of FIG. 3 with the primary exception that the one or more surfaces (defining the basin(s)) include four sloped bottom surfaces defining a W-shaped cross-section such that the one or more surfaces define two basins each having a V-shaped cross-section with a lower elevation at the vertex of the V-shaped cross-section. In the embodiment shown, the drainage structure comprises two drainage structures 54 each corresponding to a different one of the two basins, and the platform comprises a platform disposed in each basin (e.g., two platforms). In the embodiment shown, each drainage structure is similar to that of FIG. 5(B) having a flattened drainage pipe, with liner 90 passing under the flattened drainage pipe.

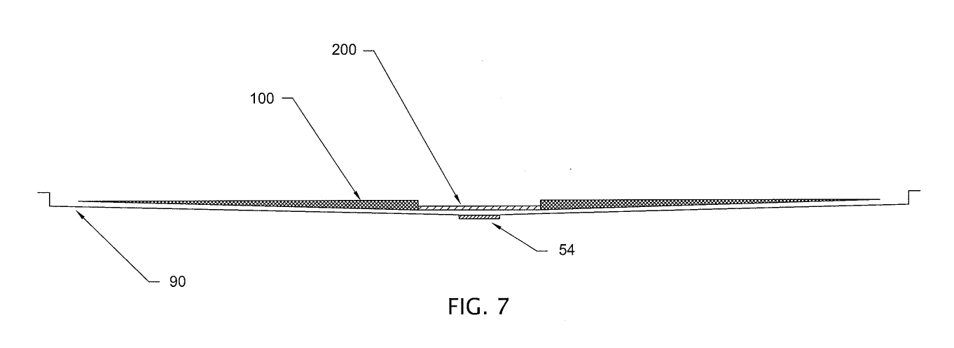

Referring now to FIG. 7, another embodiment of the present watering systems is shown. The embodiment of FIG. 7 is similar to the embodiments shown in FIGS. 2 and 3, with the primary exception that the watering system of FIG. 7 comprises a walkway 200. In some embodiments, the walkway is integral to the platform or platforms. In the embodiment shown, the walkway is disposed above and substantially parallel to at least a portion of the drainage structure. Additionally, in the embodiment shown, the walkway and at least a portion of the drainage structure are elongated and angled relative to (e.g., disposed perpendicular to) the slope of the sloped bottom surfaces. In the embodiment shown, the platform comprises a first platform and the apparatus further comprises: a second platform shaped to be placed in the basin, where the second platform: has a first side edge and an opposing second side edge that is thicker than the first side edge; and includes at least a portion that is porous (in some embodiments, the second platform may be characterized by at least one dimension of at least five feet, and at least one other dimension of at least ten feet); and a third platform (e.g., defining the walkway) configured to be coupled (and shown coupled) to and between the first and second platforms, the third platform being thinner than the second side edges of the first and second platforms. In the embodiment shown, each referenced platform (e.g., the first, second, and third platforms, and all platforms referenced elsewhere) may comprise multiple sections couplable (e.g., coupled) together as described above. This embodiment may include at least one liner, as shown.

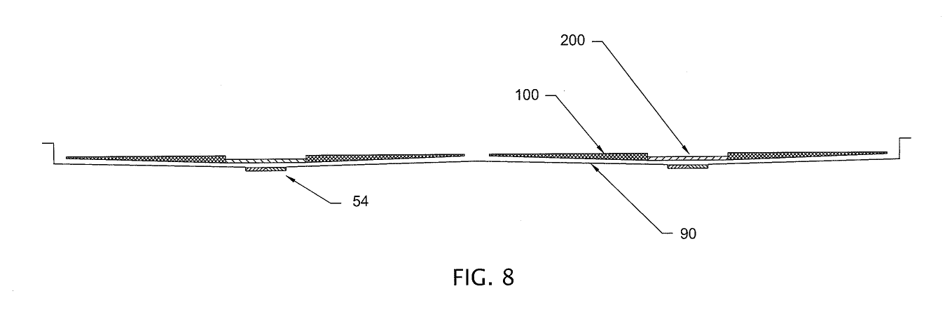

Referring now to FIG. 8, another embodiment of the present watering systems is shown that is substantially similar to the embodiment of FIG. 7 with the primary exception that the one or more surfaces (defining the basin(s)) include four sloped bottom surfaces defining a W-shaped cross-section such that the one or more surfaces define two basins each having a V-shaped cross-section with a lower elevation at the vertex of the V-shaped cross-section. In the embodiment shown, the drainage structure comprises two drainage structures each corresponding to a different one of the two basins, and the platform comprises a platform disposed in each basin (e.g., two platforms). In the embodiment shown, the system comprises two walkways (e.g., each disposed above and substantially parallel to a different one of the two drainage structures). This embodiment may include at least one liner, as shown.

Referring now to FIG. 9, another embodiment of the present watering systems is shown that is similar to the embodiment of FIG. 3 with the primary exception that the vertex of the V-shaped cross-section is above the lower elevation of the basin such that the one or more surfaces define two basins each having a lower elevation, and the drainage structure comprises two drainage structures each corresponding to a different one of the two basins. In this embodiment, a plurality of the platform of FIG. 4 can be disposed side-to-side (either thin side to thin side, or thick side to thick side, as appropriate), and/or any other suitable platform construction or configuration can be used. This embodiment may include at least one liner, as shown.

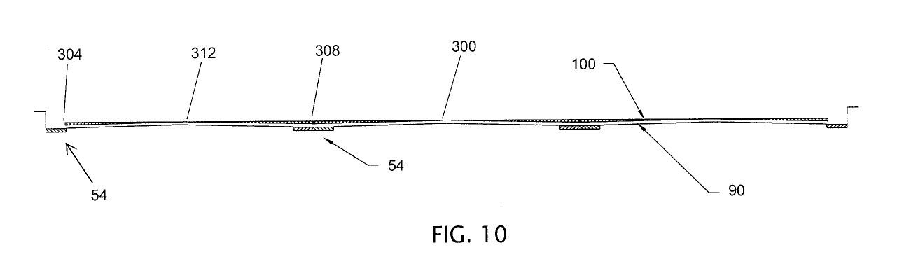

Referring now to FIG. 10, another embodiment of the present watering systems is shown that is similar in some respects to the embodiments of FIGS. 6 and 9, with the primary exception that the embodiment of FIG. 10 includes a combination of the embodiments of FIGS. 6 and 9 such that the one or more bottom surfaces define a plurality of basins, including the two V-shaped basins of the embodiment of FIG. 6, and the two half-V-shaped basins of FIG. 9. As with the apparatus and platform of FIG. 4, the apparatus shown in FIG. 10 is configured to support plant containers in a greenhouse, and comprises: a platform shaped to be placed in a basin defined by at least a portion of a floor of the greenhouse, where the platform: has a first side edge 300 and an opposing second side edge 304 that is thicker than the first side edge; and includes at least a portion that is porous. In some embodiments, the platform may be characterized by at least one dimension of at least five feet, and at least one other dimension of at least ten feet. However, the platform of FIG. 10 is also configured to comprise in use a first intermediate longitudinal section 308 and a second intermediate longitudinal section 312, where first intermediate longitudinal section 308 is thicker than first side edge 300 and second side edge 304 is thicker than second intermediate longitudinal section 312. In some embodiments, the platform of FIG. 10 comprises multiple sections couplable together (e.g., longitudinal sections and/or multiple platforms of FIG. 4 coupled together).

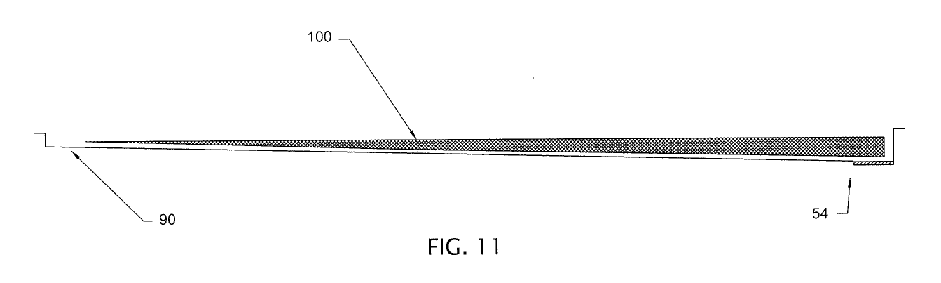

Referring now to FIG. 11, another embodiment of the present watering systems is shown that is similar to the embodiment of FIG. 3, with the primary exception that the basin has a half-V-shaped cross-section (e.g., has a bottom surface sloping or “cascading” from one side to an opposing side, such as, for example, substantially without a vertex in between). In this embodiment, the apparatus and/or platform of FIG. 4 can be sized for the particular size and/or slope of the basin.

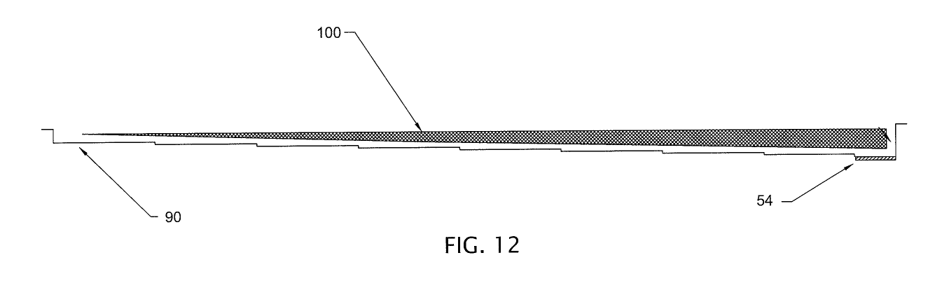

Referring now to FIG. 12, another embodiment of the present watering systems is shown that is similar to the embodiment of FIG. 11, with the primary exception that the one or more surfaces (defining the basin) include a plurality of stepped (e.g., stepped or “scallioned” from an upper step elevation to a plurality of sequentially lower step elevations, such as, for example, with the lowest step elevation being even with the lower elevation of the basin) bottom surfaces and a plurality of side surfaces (e.g., two side surfaces, such as, for example, substantially vertical side surfaces). In this embodiment, the apparatus and/or platform of FIG. 4 can be sized for the particular size and/or slope of the basin.

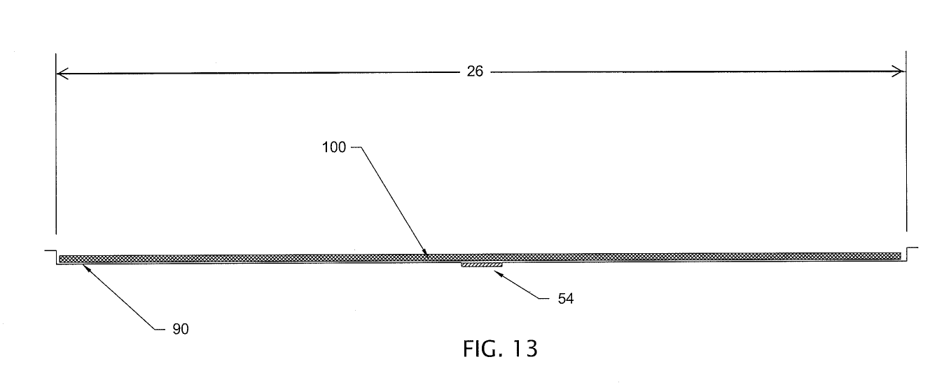

Referring now to FIG. 13, another embodiment of the present watering systems is shown that is similar to the embodiment of FIG. 3, with the primary exception that the one or more surfaces (that define the basin) include a substantially level bottom surface and a plurality of side surfaces (e.g., two side surfaces, such as, for example, substantially vertical side surfaces). The apparatus of FIG. 13 is configured to support plant containers in a greenhouse, and comprises: a platform shaped to be placed in a basin defined by at least a portion of a floor of the greenhouse, where the platform includes at least a portion that is porous (in some embodiments, the platform may be characterized by at least one dimension of at least five feet, and at least one other dimension of at least ten feet); and a liner over which the platform is configured to be positioned. As with other embodiments, the platform can comprise multiple sections couplable together.

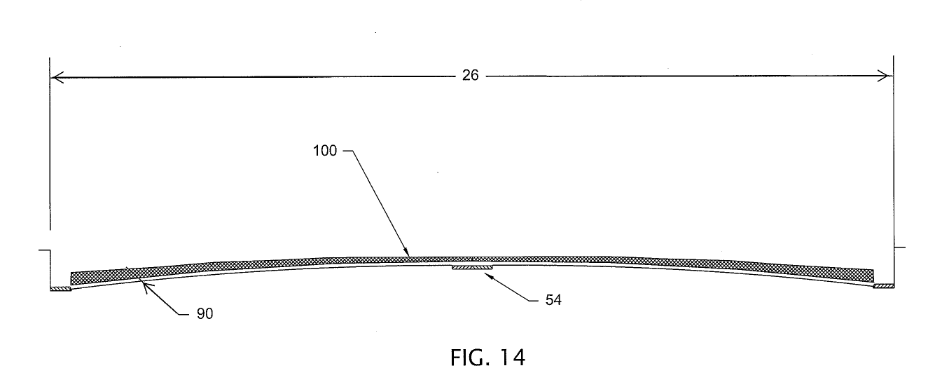

Referring now to FIG. 14, another embodiment of the present watering systems is shown that is similar to the embodiment of FIG. 9, with the primary exception that the one or more surfaces include a surface with a curved cross-section defining at least a portion of a bottom of the basin, and the curved cross-section is convex such that the midpoint of the curved cross-section is above the lower elevation of the basin and such that the one or more surfaces define two basins each having a lower elevation. The apparatus shown in FIG. 14 is configured to support plant containers in a greenhouse, and comprises: a platform shaped to be placed in a basin defined by at least a portion of a floor of the greenhouse, where the platform is configured to comprise in use a first side edge, an opposing second side edge, and a middle portion, the middle portion being thinner than the first side edge and than the second side edge; where the platform includes at least a portion that is porous. In some embodiments, the platform may be characterized by at least one dimension of at least five feet, and at least one other dimension of at least ten feet. In some embodiments, the platform of FIG. 14 comprises multiple sections couplable together.

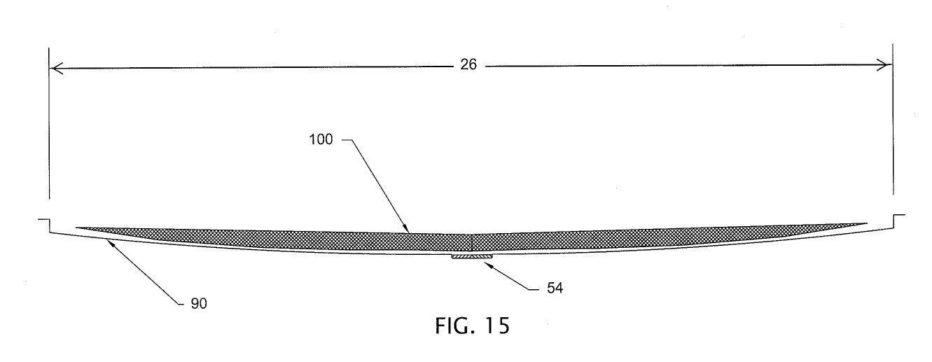

Referring now to FIG. 15, another embodiment of the present watering systems is shown that is similar to the embodiment of FIG. 3, with the primary exception that the one or more surfaces include a surface with a curved cross-section defining at least a portion of a bottom of the basin, and the curved cross-section is concave such that the midpoint of the curved cross-section is at the lower elevation of the basin. The apparatus of FIG. 15 is similar to the apparatus of FIG. 3 in that the apparatus of FIG. 15 is configured to support plant containers in a greenhouse, and comprises: a platform shaped to be placed in a basin defined by at least a portion of a floor of the greenhouse, where the platform is configured to comprise in use a first side edge, an opposing second side edge, and a middle portion, the middle portion being thicker than the first side edge and than the second side edge; where the platform includes at least a portion that is porous. In some embodiments, the platform may be characterized by at least one dimension of at least five feet and at least one other dimension of at least ten feet. In some embodiments, the platform of FIG. 15 comprises multiple sections couplable together. Any of the present embodiments may be modified or configured to include curved surfaces or portions similar to those of FIGS. 14 and 15.

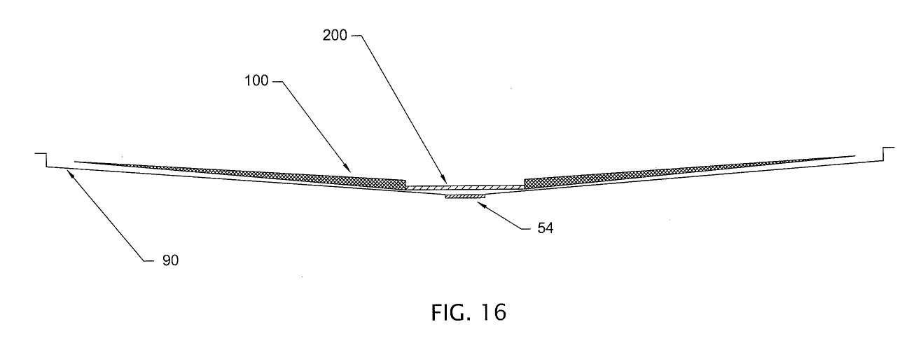

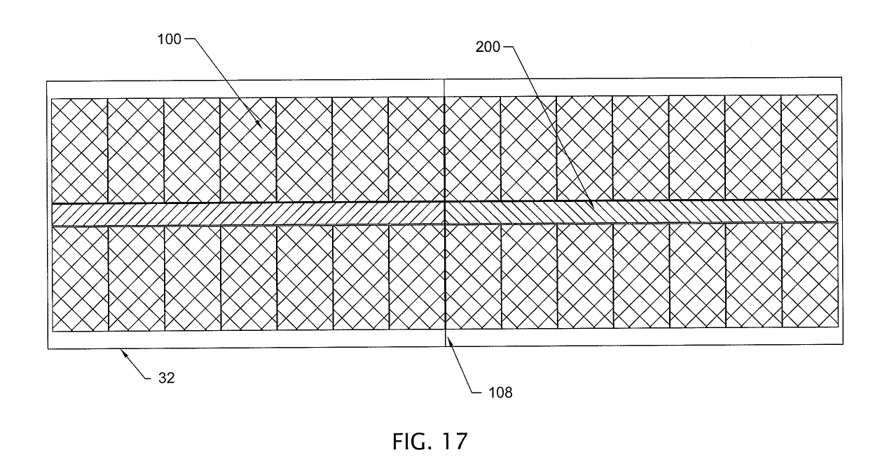

Referring now to FIGS. 16 and 17, FIG. 16 depicts a cross-sectional end view of another embodiment of the present watering systems; and FIG. 17 depicts a top plan view of the embodiment of FIG. 16. The embodiment of FIGS. 16 and 17 is similar to the embodiment of FIG. 7, with the exception that the platforms are each configured to support a plurality of plant containers at a plurality of support elevations. For example, when each platform is disposed on an angled bottom or floor surface as shown, the upper part of the platform is angled (not level). This configuration may be less expensive to manufacture, while still permitting plants supported on the platform to be close enough to one another in elevation to realize at least some of the benefits of the present watering systems. The platforms of this embodiment (with an angled upper surface) may be applied to or use with any of the present embodiments (e.g., those with W-shaped floors). By way of example, in the embodiment shown, each segment of the platform has lateral dimensions of about 4 feet by about 9 feet.

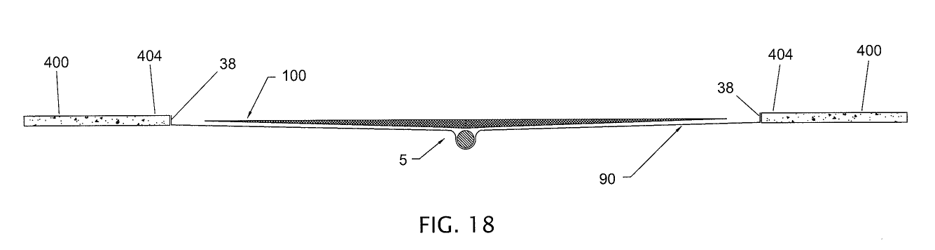

Referring now to FIG. 18, another embodiment of the present watering systems is shown that is similar to the embodiment of FIG. 3, with the primary exception that side surfaces 38 are at least partially defined by paths 400 each having a rectangular cross-section. Paths 400 can comprise, for example, concrete and/or other suitably durable materials. In the embodiment shown, liner 90 is configured to extend upward from bottom surfaces 34 along side surfaces 38 to or near an upper surface 404 of each path 400. Liner 90 may be coupled to paths 400 (e.g., at or near side surfaces 38) by any suitable means, such as, for example, screws, nails, adhesive, or the like. In the embodiment shown, the watering system includes the drainage structure of FIG. 5(C) in which liner 90 extends under a round drainage pipe.

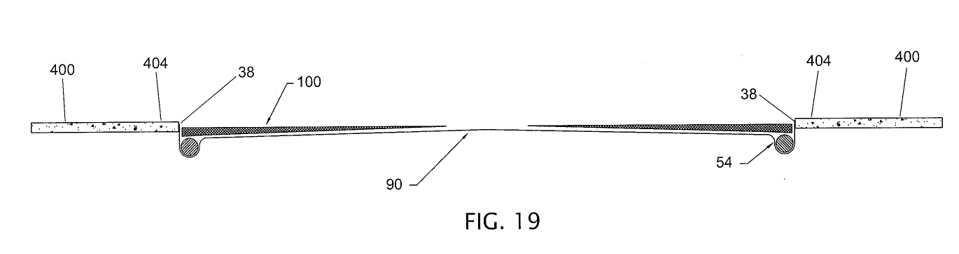

Referring now to FIG. 19, another embodiment of the present watering systems is shown that is similar to the embodiment of FIG. 9, with the primary exception that paths 400 similar to those of the embodiment of FIG. 18 are included which at least partially define side surfaces 38. Additionally, the embodiment of FIG. 19 includes a drainage structure similar to that of FIG. 5(C) (but located at a lateral low-point) in which liner 90 extends under a round drainage pipe.

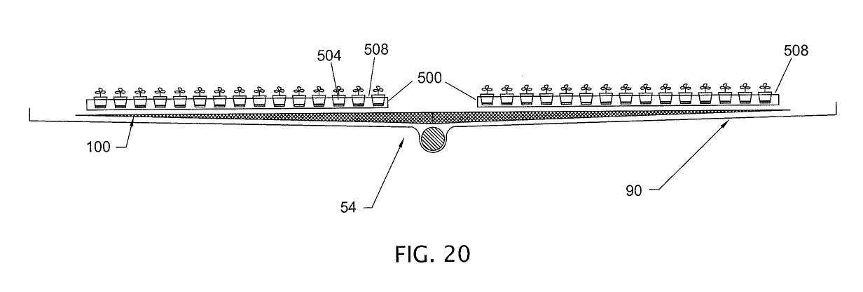

Referring now to FIG. 20, another embodiment of the present watering systems is shown that is similar to the embodiment of FIG. 3, with the primary exception that the system includes trays 500 disposed on or otherwise supported by the platforms. In the embodiment shown, trays 500 may include any of the types of trays that are typically used in the industry to hold multiple individual plant containers 504, and may be porous or frame-like to permit water to enter the trays and made from metal, plastic, and/or any other suitable material. Trays 500 include an upper boundary member 508 (upper peripheral lip of the tray, or the upper edge portion of a sidewall of the tray) that extends around a perimeter of at least a section of the platform and above the bottom of plant containers 504 (if containers 504 are resting on a container-supporting surface of the platform) to limit lateral movement of plant containers 504 (e.g., to prevent containers 504 from escaping the perimeter of a tray 500 when the region is flooded with water for watering such that containers 504 may experience buoyancy). In the embodiment shown, the watering system includes the drainage structure of FIG. 5(C) in which liner 90 extends under a round drainage pipe.

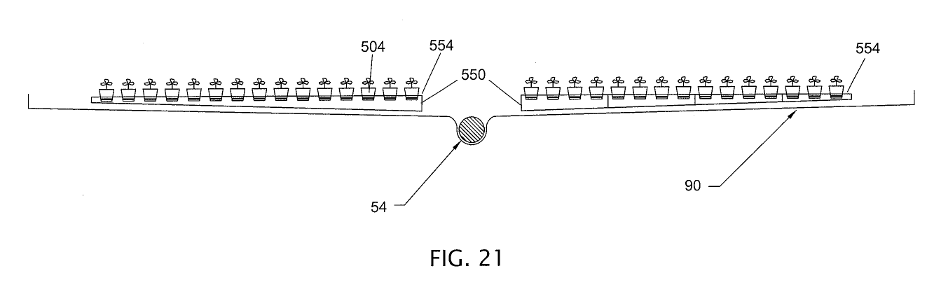

Referring now to FIG. 21, another embodiment of the present watering systems is shown that is similar in respects to the embodiment of FIG. 20. In this embodiment, the system includes trays 550 that include a surface on which plant containers 504 can be supported, and an upper boundary member 554 that is similar to upper boundary member 508 of trays 500 in that upper boundary member 554 extends around a perimeter of at least a section of given tray and above the bottom of plant containers 504 (if containers 504 are resting on a container-supporting surface of the given tray) to limit lateral movement of plant containers 504 (e.g., to prevent containers 504 from escaping a perimeter when the region is flooded with water for watering such that containers 504 may experience buoyancy). As the right side of FIG. 21 shows, multiple trays 550 can be used to cover a given portion of the underlying surface (e.g., a given portion of liner 90), and both sides of FIG. 21 show that different trays may have different thicknesses, or heights. Furthermore, each tray 550 is an example of a tray that includes a portion that is porous, that has a height and a length, and the height varies at different locations along the length. In some embodiments of the FIG. 21 system, adjacent trays 550 can be coupled together using any suitable connectors, such as clips, ties, screws, wire, twine, adhesive, welds, bolts, tape, or any other suitable structure or coupling device. Each of trays 550 is an example of a tray that includes a portion that is porous and that has a top surface that lies substantially in a plane and a bottom surface that is disposed at a non-zero angle to the top surface, thereby allowing the top surface of the tray to be positioned in a substantially level manner when the bottom surface is placed against a slanted surface that substantially matches the non-zero angle. Trays 500 and 550 may have any suitable dimensions, such as any of those recited above for the present platforms.

Any of the various embodiments can be configured to support a plurality of plant containers at or near a common elevation that is above the lowest portions of the bottom surface(s) such that all plants can be exposed to about, or substantially, the same amount of water; such that the plants are supported above (not in fluid communication with) any puddles that might otherwise cause rot or bacterial growth; and such that the platform reduces the volume of water required for flood watering. Furthermore, in embodiments where the basin is formed from permeable material (e.g., dirt or soil, clay, sand, or the like), a liner can be disposed above the permeable material to define a substantially impermeable basin.

The various illustrative embodiments of devices, systems, and methods described herein are not intended to be limited to the particular forms disclosed. Rather, they include all modifications and alternatives falling within the scope of the claims. For example, the present watering systems can include any number of basins in any of the shapes that are described and/or depicted.

The claims are not intended to include, and should not be interpreted to include, means-plus- or step-plus-function limitations, unless such a limitation is explicitly recited in a given claim using the phrase(s) “means for” or “step for,” respectively.

1. A platform for a watering system that comprises one or more surfaces defining a basin having an upper elevation and a lower elevation below the upper elevation, the basin configured to be fillable with liquid up to the upper elevation, the platform comprising:
a platform configured to be disposed on at least one of the one or more surfaces such that the platform can support one or more plant containers at one or more support elevations between the upper and lower elevations of the basin.

2. A watering system comprising:
one or more surfaces defining a basin having an upper elevation and a lower elevation below the upper elevation, the basin configured to be fillable with liquid up to the upper elevation;
a platform disposed on at least one of the one or more surfaces and configured to support one or more plant containers at one or more support elevations between the upper and lower elevations of the basin.

3. The watering system of claim 2, further comprising:
a drainage structure having a top elevation that is substantially even with or below the lower elevation of the basin, the drainage structure configured such that if liquid is in the basin drainage can be selectively permitted or prevented from the basin into the drainage structure.

4. The watering system of claim 3, where the platform is configured such that when the platform is disposed on the at least one of the one or more surfaces, at least five percent less liquid is required to fill the basin with liquid to the uppermost support elevation than is necessary to fill the basin to the same elevation when the platform is not in the basin.

5. The watering system of claim 4, where the platform is configured such that when the platform is disposed on the at least one of the one or more surfaces, at least fifteen percent less liquid is required to fill the basin with liquid to the uppermost support elevation than is necessary to fill the basin to the same elevation when the platform is not in the basin.

6. The watering system of claim 5, where the platform is configured such that when the platform is disposed on the at least one of the one or more surfaces, at least twenty five percent less liquid is required to fill the basin with liquid to the uppermost support elevation than is necessary to fill the basin to the same elevation when the platform is not in the basin.

7. The watering system of claim 6, where the platform is configured such that when the platform is disposed on the at least one of the one or more surfaces, at least fifty percent less liquid is required to fill the basin with liquid to the uppermost support elevation than is necessary to fill the basin to the same elevation when the platform is not in the basin.

8. The watering system of claim 7, where the platform is configured such that when the platform is disposed on the at least one of the one or more surfaces, at least seventy five percent less liquid is required to fill the basin with liquid to the uppermost support elevation than is necessary to fill the basin to the same elevation when the platform is not in the basin.

9. The watering system of claim 8, where the one or more surfaces include a surface with a curved cross-section defining at least a portion of a bottom of the basin.

10. The watering system of claim 9, where the curved cross-section is concave such that the midpoint of the curved cross-section is at the lower elevation of the basin.

11. The watering system of claim 9, where the curved cross-section is convex such that the midpoint of the curved cross-section is above the lower elevation of the basin and such that the one or more surfaces define two basins each having a lower elevation.

12. The watering system of claim 11, where the drainage structure comprises two drainage structures each corresponding to a different one of the two basins.

13. The watering system of claim 2, where the one or more surfaces include a substantially level bottom surface and a plurality of side surfaces.

14. The watering system of claim 13, where the plurality of side surfaces are substantially vertical.

15. The watering system of claim 2, where the one or more surfaces include a plurality of stepped bottom surfaces and a plurality of side surfaces.

16. The watering system of claim 15, where the plurality of stepped bottom surfaces include a plurality of surfaced stepped from an upper step elevation to a plurality of sequentially lower step elevations.

17. The watering system of claim 2, where the one or more surfaces include a bottom surface sloping downward to the lower elevation.

18. The watering system of claim 2, where the one or more surfaces include two sloped bottom surfaces defining a bottom of the basin having a V-shaped cross-section.

19. The watering system of claim 18, where the vertex of the V-shaped cross-section is at the lower elevation of the basin.

20.-65. (canceled)

66. An apparatus configured to support plant containers in a greenhouse, the apparatus comprising:
a platform shaped to be placed in a basin defined by at least a portion of a floor of the greenhouse, where the platform:
has a first side edge and an opposing second side edge that is thicker than the first side edge; and
includes at least a portion that is porous.

67.-125. (canceled)
